(19) United States
(12) Patent Application Publication
(10) Pub. No.: US 2010/0145722 A1
(43) Pub. Date: Jun. 10, 2010

(54) SYSTEM AND METHOD FOR TRANSFERRING DATA ASSOCIATED WITH AN ELECTRONIC MEDICAL RECORDS SYSTEM

(76) Inventor: Edward Zalta, Laguna Niguel, CA (US)

Correspondence Address: Pearl Cohen Zedek Latzer, LLP, 1500 Broadway, 12th Floor, New York, NY, 10036, US

(21) Appl. No.: 12/630,160

(22) Filed: Dec. 3, 2009

Related U.S. Application Data
(60) Provisional application No. 61/200,986, filed on Dec. 5, 2008.

(51) Int. Cl. G06Q 50/00

(52) U.S. Cl. 705/2

(57) ABSTRACT

A method and system may allow a physician to traverse computerized clinical practice guidelines (CPGs) when examining, diagnosing and treating patients, allowing for “bookmarking” or pausing the CPGs. The CPGs may be updated and the updates applied to a physician's use of the CPG. A method and system may automate the process of requesting approval for a patient's treatment from an organization, e.g., referrals. A method and system may automatically inform a physician that a symptom is caused by a drug currently being taken by a patient.

### PRIOR APPLICATION DATA

The present application claims benefit of prior U.S. application 61/200,986, filed on Dec. 5, 2008, incorporated by reference herein in its entirety.

### BACKGROUND

Electronic Medical Record (EMR) systems storing and communicating patient data, and Clinical Practice Guidelines (CPGs) providing guidelines in flowchart form to medical professionals, exist. There are clear defects with such systems, such as lack of integration, non-computerized bottlenecks, and other issues. EMR and Computerized Patient Record (CPR) systems help providers comply with mandatory documentation of medical encounters and the complex, differing and changing requirements of health care systems. Health care data is best documented by the use of computers at the time of an encounter (e.g., a doctor-patient encounter). Links between EMR systems and laboratories, radiological services, allied health services, hospitals, and pharmacy providers are already functional.

Over 1,600 CPGs exist in written format, several hundreds in a decision tree format. A subset of these include annotations which serve to inform the user of the evidence-based rationale behind the decision tree. CPGs are not incorporated into computer systems in a way allowing a doctor to effectively use the CPGs.

Indications (e.g., the reasons a patient is seeing a doctor, or the reasons the patient requires a hospital admission, prescription, treatment, or a referral) provided in requests for referrals from primary care providers to specialists are made primarily to the offices of managed care companies formed to manage the escalating cost of health care services. These are primarily telephone-based systems that may require personnel on the user's end to verbalize the reasons for requesting a referral or to reduce the request to writing. Either method allows the personnel at the managed care end to approve or disapprove the request. Indications to approve requests for admission to a medical facility, perform surgical procedures or obtain costly tests (e.g., magnetic resonance imaging (MRI), computer aided tomography (CAT) scans, etc.) are maintained by managed care companies. The requests are also made primarily using telephone-based systems.

A great number of medical advances have been made by trial and error. Determining the “best practices” requires many years of accumulating reviews in the medical literature on the results of a particular treatment modality. Also, in evaluating the safety and efficacy of new drugs, millions of dollars are spent in clinical trials on fewer than 1,000 patients. It is only after many months or years that the medical and pharmaceutical professions become aware of undesirable side effects or whether the benefits of treatment outweigh the risks. Through the accumulation of masses of data regarding treatments and the actual outcomes of those treatments, does the medical profession adopt or modify the “acceptable” or “community standards of practice”. The use of “blood letting” based on the belief that the body replaced its total blood volume in just a few hours, and by removing large quantities of blood the “toxins” causing the patient's symptoms would be removed, and the patient would be benefited, took decades to disprove. The belief that all stomach ulcers were caused by stress was held as truthful for over a century until a thorough review of the literature and clinical trials demonstrated that the belief was ill-founded and that stomach ulcers were caused by a bacterium. This process of trial and error took many years and only after many double blind studies had shown the effectiveness or lack thereof does medical practice evolve into more effective and less costly modalities of treatment. The studies required time due to the inability to gather the data and review the literature to reveal the outcomes.

Pharmaceutical companies, medical research organizations, and clinical practice guideline developers are handicapped in their endeavors to improve the quality and lower the cost of medical care because of the absence of data from health care providers.

### SUMMARY

One embodiment of the invention includes a mid-ware software and hardware system, and a “Physician Empowerment Technology” (PET) system that may link, for example, established EMR systems, or EMR systems in accordance with embodiments of the present invention, on the front end, with developers' CPGs, medical researchers, and pharmaceutical providers on the back end. Such a mid-ware linkage, linking data such as a patient's demographics and ancillary facilities, the best medical practice modalities and the requirements of managed care (such as pre-certification, referral control) may be followed. The results of therapy may be furnished to pharmaceutical companies or other institutions to for example evaluate the differences in gender, age, and ethnic responses to medications as well as affording developers of CPGs to evaluate the results of their recommended treatments. CPGs may be modified in response to this knowledge. Patients may be provided with the best medical practice for a given condition and the providers may be able to unburden themselves of the time-consuming task of seeking approval for needed medical tests or procedures.

An embodiment of the invention includes a PET system that includes computerized CPGs and includes annotations to allow the provider to follow the right pathway in the right sequence at the right time to obtain the right result. Outcomes research may be performed. The PET CPGs may incorporate a “feed back” system which allows for the recapture of patient outcomes in electronic format as providers navigate through the CPGs. Confidentiality may be maintained. As outcomes dictate which modality of treatment results in the most desirable outcome, the CPGs may be constantly updated, for example by a guideline developer, so that the user is always presented with the most advantageous pathway to improve treatment outcomes. Medical alerts, for example regarding newly discovered treatments or adverse reactions or drug recalls, may be introduced into the provider's practice pattern (e.g., by being introduced into CPGs) instead of relying on printed bulletins and provider education or recall.

In an embodiment of the invention, a system or PET may receive for example a list of medications that a patient is presently taking from an EMR, as well as for example the presenting symptoms. The medications the patient is taking may be compared to the symptoms or signs the patient is exhibiting. When a symptom or sign is known to be a likely side effect of the medication, the practitioner may be alerted to the possibility. A system or PET may review the medications that the patient is presently taking and the drugs that are being prescribed after completion of a diagnosis or a CPG and medication selection. In the event of a possible adverse interaction between drugs the provider may be notified as to the possible drug/drug interaction. In the event of, for example, a drug recall, the system may provide a list of patients, for example by number and physician, or other identifying criteria, so that all patients taking the drug may be notified of the recall.

In an embodiment of the invention, a system or PET may computerize the indications which may allow for the automatic transmission of a request for a referral, prescription, admission to a medical care facility, or another request, along with the selected indications to the managed care entity thus reducing the cost and wait times to obtain approval.

Embodiments of the invention may to improve the quality of health care and reduce its costs by the elimination of “defensive medicine” (e.g., described as unnecessary tests and procedures).

Embodiments of the invention include systems implementing the various methods disclosed herein. The systems may of course implement other methods as well. Individual features of specific embodiments may be combined with other embodiments.

### BRIEF DESCRIPTION OF THE DRAWINGS

Embodiments of the invention are illustrated by way of example and not limitation in the figures of the accompanying drawings, in which like reference numerals indicate corresponding, analogous or similar elements, and in which:

FIG. 1 schematically illustrates a medical information system in accordance with an embodiment of the invention;

FIG. 2 schematically illustrates portions of a medical information system shown in FIG. 1 in accordance with an embodiment of the invention;

FIG. 3 is a flowchart depicting a CPG functionality according to one embodiment of the invention;

FIG. 4 is a screen display showing a list of CPGs that may be presented to a physician according to one embodiment of the invention;

FIG. 5 is a screen display showing a question that may be presented to a physician according to one embodiment of the invention;

FIG. 6 is a flowchart depicting method of requesting pre-certification, admission, referral, or other permission from an organization, according to one embodiment of the invention;

FIG. 7 is a screen display showing a list of diagnoses and corresponding codes that may be presented to a physician according to one embodiment of the invention;

FIG. 8 is a screen display showing questions asked to a physician when requesting a referral according to one embodiment of the invention;

FIG. 9 is an example of a referral request form, according to an embodiment of the invention;

FIG. 10 is a flowchart depicting a method for providing interaction information according to one embodiment of the invention; and

FIG. 11 is a schematic diagram depicting modules according to one embodiment of the invention.

It will be appreciated that for simplicity and clarity of illustration, elements shown in the figures have not necessarily been drawn to scale.

### DETAILED DESCRIPTION

In the following detailed description, numerous specific details are set forth in order to provide a thorough understanding of embodiments of the invention. However it will be understood by those of ordinary skill in the art that embodiments of the invention may be practiced without these specific details. In other instances, well-known methods, procedures, components and circuits have not been described in detail so as not to obscure the embodiments of the invention.

The processes presented herein are not inherently related to any particular computer, network, or other apparatus. Various general-purpose systems may be used with programs in accordance with the teachings herein, or it may prove convenient to construct a more specialized apparatus to perform embodiments of a method according to embodiments of the present invention. Embodiments of a structure for a variety of these systems appear from the description herein. In addition, embodiments of the present invention are not described with reference to any particular programming language. A variety of programming languages may be used to implement the teachings of the invention as described herein.

Unless specifically stated otherwise, as apparent from the following discussions, throughout the specification discussions utilizing terms such as “processing,” “computing,” “calculating,” “determining,” or the like, refer to the action and/or processes of a computer or workstation, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

Embodiments of the invention may manipulate data representations of real-world entities such as patients; patients' indications, symptoms, conditions, or other physical aspects of patients; diagnoses representing physical conditions of patients; medical records which may be in paper form (e.g., images of medical records or electronic versions of the information contained in medical records); data regarding the outcomes of treatment; or requests for treatment (where the treatment itself is a real-world physical process). Embodiments of the invention may process and organize this data representing real-world entities, transmit such data among various entities, provide medical treatment recommendations based on such data, allow users to access or search the data, and present the data to users.

In one embodiment of the invention, a system or PET may computerize the sending or indications or requests for referrals or admissions which may allow for the automatic transmission of a request for a referral along with the selected indications to the organization paying for medical treatment, possibly reducing the cost and wait times to obtain approval. A doctor may select an indication from a set of indications or based on the entry of a diagnosis or symptom, or based on answers to a series of questions, the indication being tailored to precisely and completely answer the question that might be asked by an organization paying for medical treatment (e.g., an insurance company, a managed care entity, a health maintenance organization (HMO), a government agency, etc.). The indication may be, for example “Hoarseness/Throat pain; foreign body sensation in throat; refer to otolaryngologist.” A request may be automatically created for a physician, including the indication. The indication may be transmitted electronically or otherwise along with the request for, e.g., a referral, admission, or prescription. The transmission may be sent via a network such as the Internet, to an organization paying for medical treatment. The request may be printed and sent to the organization, e.g., by facsimile. At the organization, a decision may be made whether or not to approve the request, for example by an employee of the organization. The approval or denial of the request may be sent back to the doctor along with other information such as an authorization number or requests for more information via the same network. Such a system may make such requests more efficient, since the indications sent to the organization may be the precise indications required to fulfill the requirements for the request.

Organizations such as pharmaceutical companies, medical research organizations, and CPG developers are handicapped in attempting to improve the quality and lower the cost of medical care because of the absence of data, or of the difficulty of accessing data. An embodiment of the invention provides these organizations with data, such as for example a pathway taken through a process (e.g., a record of the branches and information taken within a CPG) which may detail the diagnostic and treatment selections, the results of laboratory and radiologic tests, the treatment outcomes, or the complications of treatment. The traversal and input to and output from a CPG may be documented by a system in a machine readable format. This information may be continuously recorded on each patient visit or doctor interaction with a particular CPU-patient instance, and the sanitized information (e.g., confidentiality protected) may be made available to CPG developers who can determine the need for modifications, researchers to determine the best practices, drug complications, side effects, gender/ethnic differences in reactions drugs to the pharmaceutical companies, and outcomes to the Agency for Healthcare Research and Quality for continued evaluation of the effectiveness of modalities of treatment and the need to de-certify or reinforce those modalities. This may provide the ability to conduct outcomes research, modify products, tailor them for specific groups (e.g., gender/age/ethnicity), and continually update CPGs so that patients are provided with the right treatment in the right sequence at the right time in order to obtain the right outcome. Outcome or results data sent from medical service providers (e.g., doctors) may include, for example, what happens to a patient as a result of a doctor following CPGs, statistics regarding a patient's condition, a patient's ethnicity, diagnosis, and treatment. Patient confidentiality may be maintained in that no patient identifying information is transmitted, patients being identified only by for example the patient number or ID recorded in the treating physician's filing system.

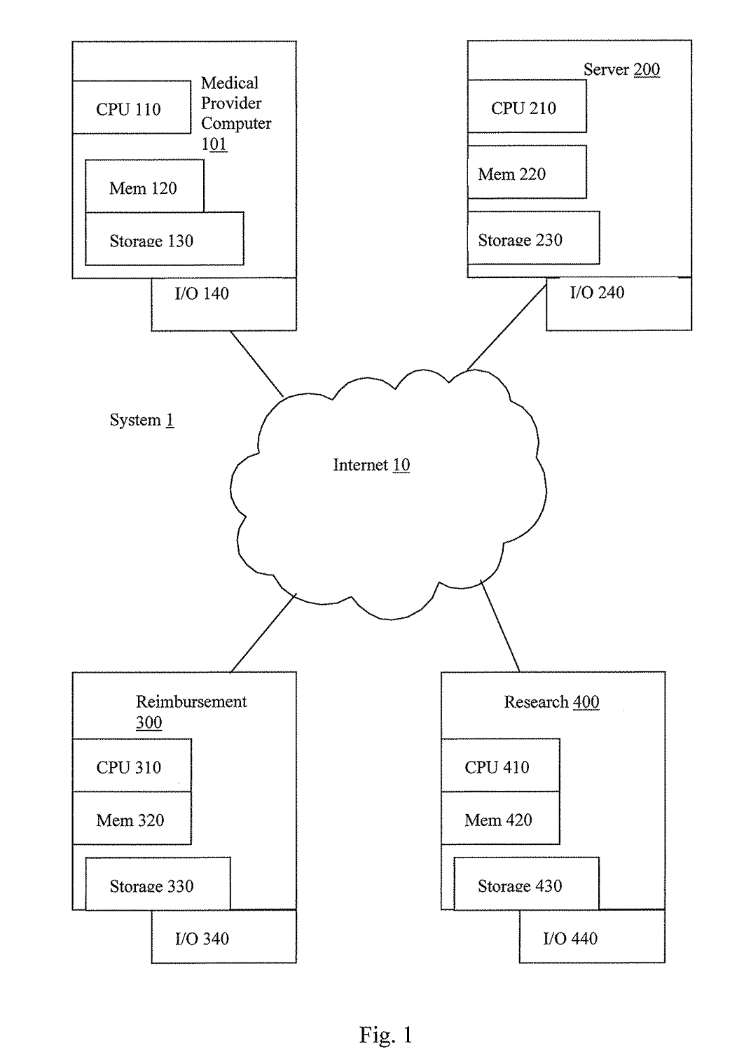

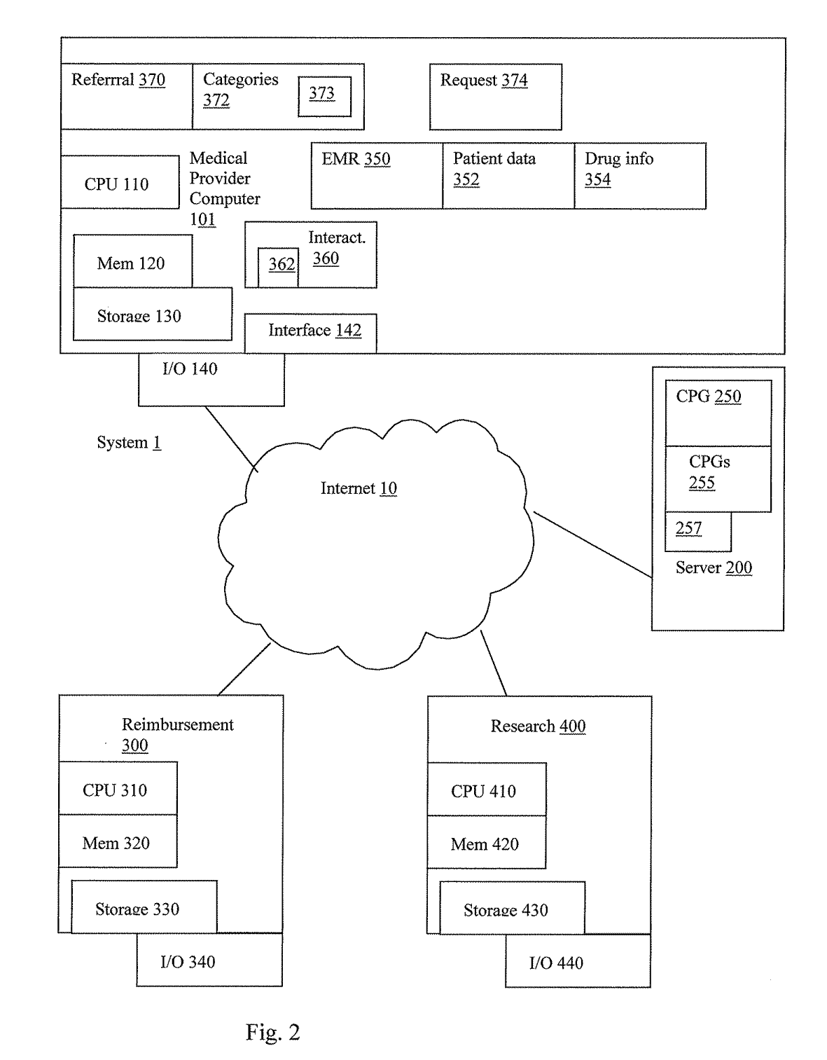

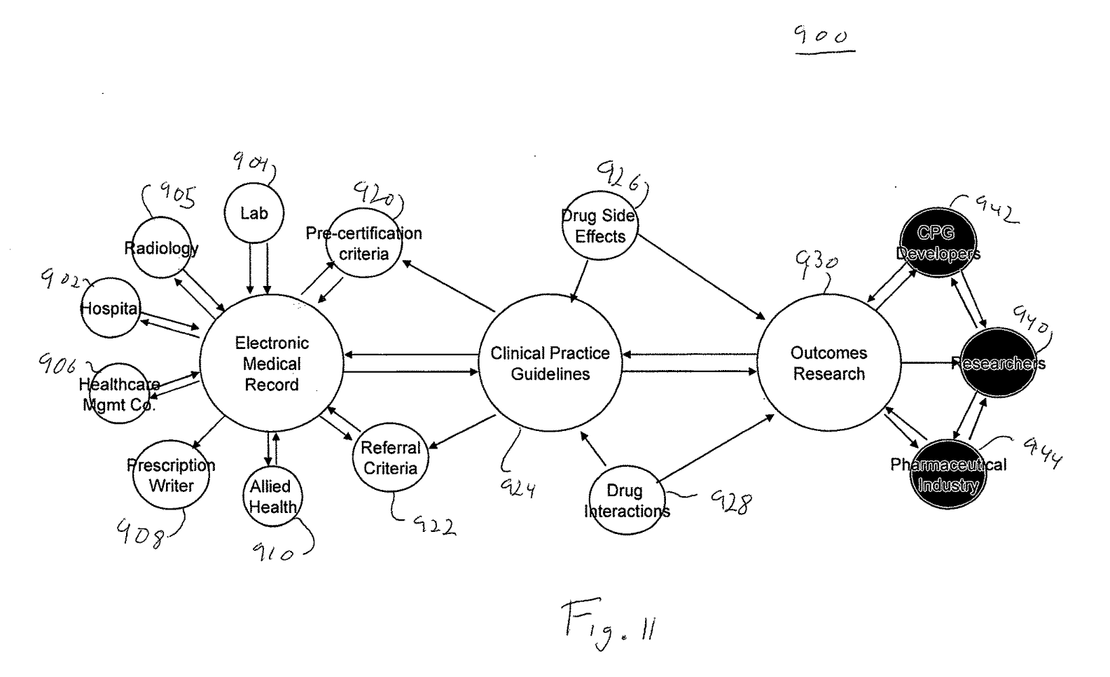

FIG. 1 schematically illustrates a medical information system in accordance with an embodiment of the invention. The systems in FIGS. 1 and 2 may implement the functionality and modules shown in FIG. 11, and/or other functionality and modules.

A medical information system 1 may include one or more medical provider computer systems 101 located at one or more medical provider offices, one or more server(s) 200, one or more reimbursement computer systems 300, located at one or more organizations paying for medical treatment such as reimbursement organizations 300, and one or more research organization computers 400 located at one or more research organizations (e.g., universities, CPG developers, pharmaceutical companies) 400, connected by one or more communications networks such as Internet 10.

Each of medical provider computer system 101, servers 200, reimbursement computer system 300, and research organization computer 400 may include components such as processors 110, 210, 310, and 410, memories 120, 220, 320, and 420, long term storage (e.g., hard disk drive, removable memory, etc.), 130, 230, 330, and 430, and input/output (110) devices such as monitors, keyboards, pointing devices (e.g., mouse, etc.) 140, 240, 340, and 440.

Computers 101, 200, 300 and 400 may be for example personal computers, workstations, simple terminals, or other sorts of computer systems, and may include components and capabilities other than what is shown in the examples provided.

FIG. 2 schematically illustrates portions of a medical information system shown in FIG. 1 in accordance with an embodiment of the invention.

Medical provider computer system 101 may include EMR 350, and drug interaction module 360 (preferably embedded within, working closely with, or callable from EMR 350), each of which may be for example code stored in memory 120 or storage 130 and executed by processor 110 (as may be other modules discussed herein). EMR 350 may include or be associated with a database such as patient records 352 which may include, among other information, patient identifications (IDs) associated with patient medical records, current drug information 354, data listing, for a set of patients in patient records 352, which drugs each patient takes. Drug interaction module 360 may include or be associated with a database such as drug interaction data 362.

Medical provider computer system 101 may execute a user interface program 142 (e.g., a web browser, a graphical user interface (GUI)) which may provide an interface to a user, accepting input and providing output. The functionality of a program whose interface is presented to a user via user interface program 142 may be provided by a program being executed by system 101, or by another system (e.g. a server 200), in which case input and output is transmitted from system 101 to the other computer system via for example Internet 10.

Medical provider computer system 101 may include indication/referral module 370, which may be for example code stored in memory 120 or storage 130 and executed by processor 110. Indication/referral module 370 may aid a medical service provider in requesting admissions, referrals, or other permissions needed from a reimbursement organization 300. Indication/referral module 370 may use or access indications/referrals and indication/referral categories 372 (which may be, or may be stored in, a database) such as, stored for example memory 120 or storage 130. In FIG. 2, a specific indication 373 is shown which can be transmitted along with a request 374 from medical provider computer system 101 to one of reimbursement organizations 300. In alternate embodiments, some or all of the functionality and storage of indication/referral module 370 and indications/referrals and indication/referral categories 372 may be at another location, for example a server 200 (other modules may similarly be executed at server 200). In such a case the indication/referral module 370 may interact with a user such as user interface program 142, exchanging data (e.g., user input, output from module 370) via a network such as Internet 10.

CPG module 250 may provide CPG functionality to medical providers using CPGs 255. CPG module may include bookmarks and other local data 257, storing information specific to individual practitioners and patients. In one embodiment CPG functionality is provided via servers 200, and CPG module 250, CPGs 255 and local data 257 may databases, and may be stored in memory 220 and/or storage 230 (FIG. 1) and CPG module 250 may be executed by processor 210. CPG module 250 may interact with a medical professional by being executed on server 200 and presented on a user interface at medical provider computer system 101. Input to CPG module 250 may be received by medical provider computer system 101. Input to and output by CPG module 250 may be transmitted by Internet 10. In an alternate embodiment all or part of CPG module 250, CPGs 255 and bookmarks and local data 257 may be stored and executed on medical provider computer system 101, or on another computer system.

Server 200 may generate and support client side interfaces. For example, an interface generated by server 200 may be executed or displayed by user interface program 142. Server 200 may have two-way connections such that server 200 may read input and write output, for example, from and to computers 101 and other computers via for example user interfaces using one or more communications networks such as Internet 10. Server(s) 200 may include software (e.g., code and instructions) stored for example in memory 220 and/or storage 230 that when executed by a processor such as processor 210 causes the processor to accept, organize, and present medical information, to operate a GUI, or perform other functions.

While various structures and modules such as referral module 370 and CPG module 250 are shown as being part of server 200 or computer 101, the arrangement in certain embodiments may differ, and some of these structures may be partially held or represented in other units.

CPG Functionality/Outcomes Research

In one embodiment of the invention, a system may accept a description associated with a CPG (e.g., a name, a code) and select the CPG for execution based on this description. After receiving information from a doctor, instructions (e.g., a request for a test) relevant to the patient may be provided to the doctor. Each question and instruction may correspond to a location within a CPG. The doctor may input a bookmark command, and in response the system may save an identifier for the patient and the location of the examination within the CPG (e.g., to a database). The system may receive data (e.g., a patient ID) from the doctor regarding a different patient, and the system may, based on the patient ID or a selected CPG, accept answers to questions and provide an instruction to the doctor regarding the second patient based on the CPG. The doctor may, after bookmarking the CPG relevant to the second patient, return to the examination of the first patient, for example by providing to the system a request to continue using the first CPG and the ID of the first patient.

In one embodiment CPG functionality is located on and executed by a central master server such as a server 200, but in other embodiments, CPG functionality may be located on another computer system, such as at a doctor's office on computer system 101. Locating CPU functionality on a central server may allow for instant modification as new modalities are discovered, e.g., CPGs 255 may be modified easily and quickly as new information is determined, and this functionality may be used immediately by all providers accessing CPGs 255 via for example computer systems 101. However, even if all CPG functionality is local to provider systems 101, updates may be effected by for example sending updates to each system 101. A physician using CPGs 255 may be immediately notified of the newly authored recommendation and its source. Should the busy practitioner wish to review the reasons for a particular recommendation, annotations may be available on line (e.g. via computer system 101 accessing server 200), allowing the user to review the commentary and immediately return to the process while not delaying the rapid progression through the guideline for others.

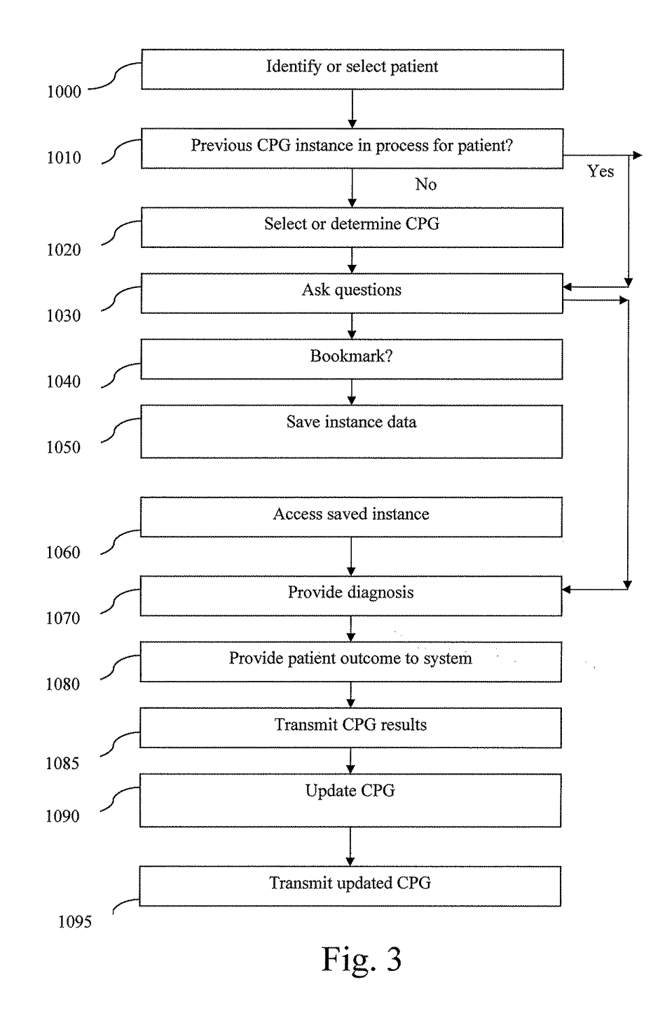

FIG. 3 is a flowchart depicting a CPG functionality according to one embodiment of the invention. The process of FIG. 3 may be implemented, for example by server 200, system 101, or by another system not shown.

In operation 1000, a provider or health professional (e.g., a physician) may enter a patient ID or otherwise identify or select a patient to computer system 101, and, if the patient is the subject of a paused CPG examination, possibly a request to continue with the CPG. The entry of a patient ID itself may be determined by a system to be a request to continue with a paused CPG. If a previous CPG (e.g., an instance of a CPG with this patient) was started and then stopped in progress for this patient ID (for example so that a test may occur or other information be gathered, or treatment provided), the process may (per decision point 1010) proceed to operation 1030 where the CPG continues evaluating the patient.

In operation 1020, a CPG (e.g., a CPG of CPGs 255) may be selected or accessed. A description associated with a CPG may be accepted by system 101, and a CPG may be selected based on the description. The description may be a name or code, or a diagnosis, associated with a CPG displayed to a user. Other methods of accepting a CPG may be used.

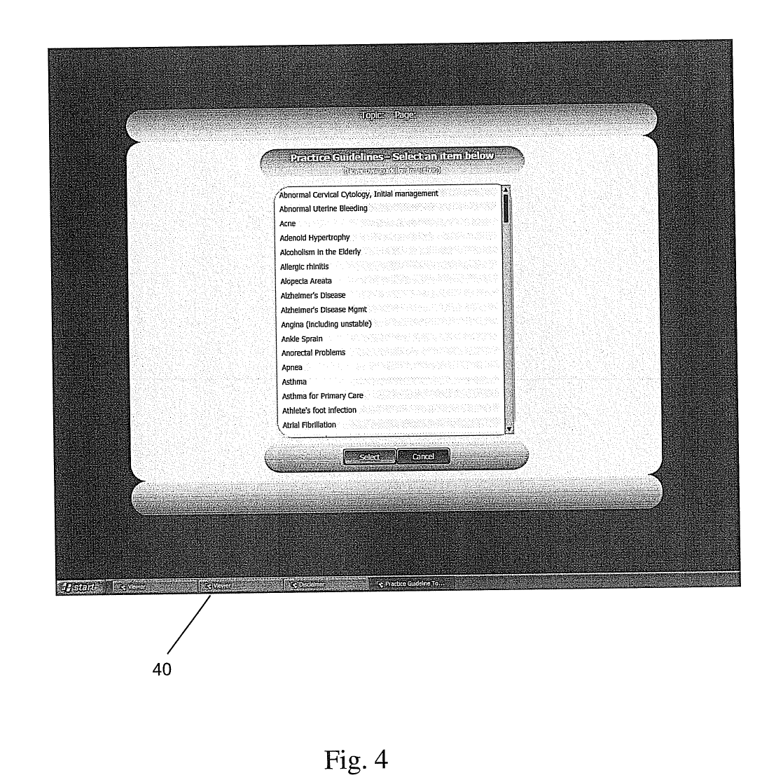

In one embodiment, system 101 may accept a patient description (e.g., a diagnosis, indication, disease, etc) associated with a CPG. For example a physician may be presented with a list of possible conditions or diagnoses, or other categories, and may choose a condition, category or diagnosis. FIG. 4 is a screen display showing a list of CPGs that may be presented to a physician according to one embodiment of the invention. Other methods of choosing a CPG may be used. The description associated with a CPG that the physician inputs may be a CPG (e.g. a title or code number) itself.

In operation 1030, based on the chosen or relevant CPG of CPGs 255, CPG module 250 may ask questions of the provider via user interface program 142. A particular CPG may have been chosen by a provider, or based on a patient ID associated with a bookmark for the CPG in a database (e.g., data 257). If the entry of a patient identification causes the system to determine (e.g., in operation 1010) that the patient was the subject of a CPG that was paused of bookmarked, the relevant data may be accessed (e.g., from data 257), and the CPG selected based on the CPG identification stored in data 257.

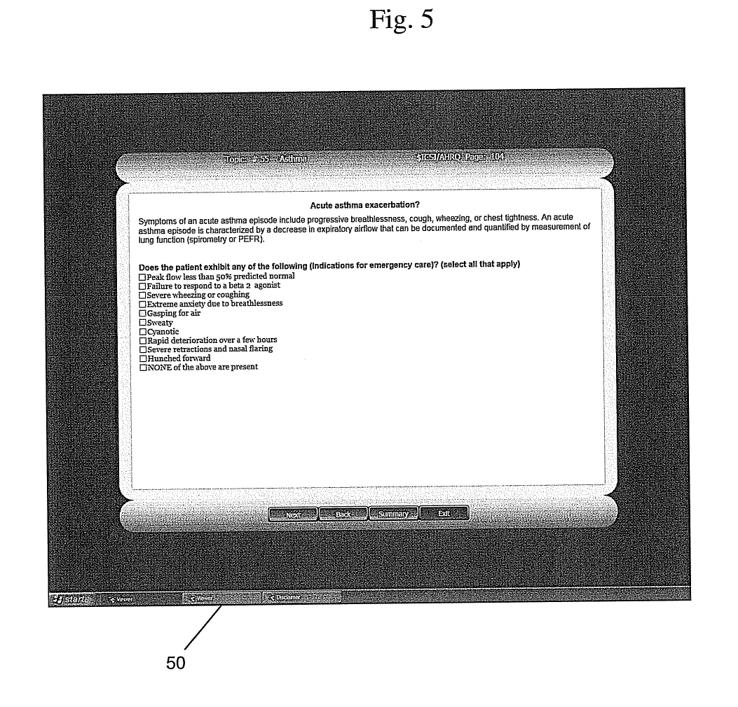

The provider may provide input to CPG module 250 and receive output from module 250 via user interface program 142. The provider may enter into interface 142, using for example a mouse or keyboard of I/O devices 140, symptoms or other information, answering questions posed by module 250. In response to the answers, module 250 makes choices about which branches of the relevant CPG to choose, and based on the selected branches, asks more questions of the physician, until in a final branch a diagnosis is provided by CPG module 250 via interface 142. System 101 and CPG module 250 may provide an instruction relating to the patient (e.g., a diagnosis, a question, a request for more information or a test, request for treatment, etc.) based on the relevant CPG to the health professional. The instruction may correspond to a specific point, page or location within the CPG which may be structured for example as a decision tree, with branch points corresponding to pages (other CPG structures may be used). In some embodiments, each set of questions may be presented on a separate page or screen display to a user. FIG. 5 is a screen display showing a question that may be presented to a physician according to one embodiment of the invention.

In operation 1040, CPG module 250 may ask if a provider or health professional wants to bookmark or pause the session at a certain point, page or location of the examination within the CPG, and the module 250 may receive a bookmark command or request from the provider. The point or location may correspond, for example, to the location in the CPG from which the instruction (e.g., request for testing, preliminary diagnosis) was generated, a page within a CPG displayed as multiple pages, or a point of examination within a CPG.

There may be a need to traverse a CPG in multiple sessions. For example, a certain test may be suggested by a CPG, the results of the test may take hours or days, and the results may dictate which branch of the CPG to take. In addition (or alternatively) a diagnosis and/or treatment may be provided, and it may be desired to stop the CPG, perform the treatment, and return to the CPG later at a point or location of examination within the CPG where the CPG will diagnose the effectiveness of the treatment.

Therefore, in some embodiments, a “bookmark” may be used, saving the place in the CPG tree information allowing the doctor and patient to leave the CPG process for a period of time, put the CPG process for a specific patient on hold, and return to the CPG process later. This information may include the specific place in the CPG where the process is stopped, a doctor ID and a patient ID and the date of exiting and re-entering the CPG. Each traversal of a specific CPG, for a specific patient, for a specific patient complaint or diagnosis, may be an “instance” of a patient-CPU traversal. A patient may have more than one instances, if different CPGs are used, or at different times the same CPU is used for a patient.

Data such as e.g., a physician or provider identification (“ID”), patient ID, patient information (e.g., age, race, sex), place in the CPG tree, etc. may be stored in bookmarks and other local data 257 on a server 200, and/or locally on system 101. The ID of the physician and/or patient may be anonymous (at least when presented to entities outside the system), in that a code or number may be used to identify the physician and/or patient, where it may be difficult or impossible to identify the real name of the physician or patient from the ID.

Additionally, data captured during the traversal regarding the traversal and outcome may be stored, for example, in memory 120, memory 220, or another storage device, for later transmission to and analysis by a party updating the CPG. For example, each (which) branch or page traversed, information inputted by a user (e.g., results of diagnoses), and outcomes (e.g., whether the patient got better, follow up tests), may be stored.

In operation 1050, if the provider has decided to bookmark the session, the relevant data (e.g., the name, code or identity of the specific CPG, patient ID, doctor ID, point or position in the CPG or the location of examination within the CPG, doctor answers) are saved, for example as a bookmark in local data 257 on a server 200, and/or locally on system 101, and the system may exit the current CPG. The data saved may be the instance of the CPG for the patient, but may be other data, e.g., a subset of instance data. The data may be saved for example in memory 120, storage 130, or in another location. While on hold, the traversal of the particular CPG for a patient by the physician, the operation of the CPG by CPG module 250, and the presentation of the CPG on interface 142 may be terminated. The data needed to restart the operation of the CPG by CPG module 250, and the presentation of the CPG on interface 142, may be stored in bookmarks and other local data 257.

In operation 1060, at some time later, the provider may request to continue a saved CPG, and may access interface 142 to call up or retrieve a particular instance of a particular saved CPG (which may be a second or different CPG from that relevant to the operations 1000-1060, or the same CPG) using, for example, a doctor ID and/or patient ID, or other information, and continue interaction with the CPG module 250 and the diagnosis using the particular CPG. For example, system 101 may receive data from the professional regarding a second patient and the CPG may continue, from the point left off last, asking questions and/or providing instructions regarding the second patient. The last-viewed page or screen or next screen of the CPG may be displayed and the physician may continue the diagnosis/treatment process for that second patient. A particular instance of a CPG may mean in this context the use of a particular CPG at a particular time for a particular patient.

“Bookmarking” may allow a user to leave a process or CPG at any point and upon seeing the same patient, the program or CPG may be opened at the last page viewed. As the user navigates through a CPU, if the guideline suggests that the user obtain a test (for example an x-ray) and the user selects this option, then the system may “bookmark” this screen as it exits the guideline. When the user later re-enters the same guideline for the same patient, it opens up on the same screen he/she left so that the user is able to continue with the guideline now armed with the results of the test (e.g., an x-ray) and does not have to start at the beginning of the guideline.

In operation 1070, when the CPG reaches the end of branching, a result, diagnosis, or suggested treatment course may be displayed to a user. System 101 may provide an instruction to the professional regarding the patient currently being applied to the CPG (e.g., a second patient, or a patient whose examination is resumed per step 1000) based on the second CPG.

In operation 1080, at some later time, a professional may input a result or an indication of an outcome at, for example, system 101. For example, whether or to what extent a patient recovered, symptoms presenting a certain time (e.g. one month) after treatment, results of follow-up tests, etc., may be input, and may be stored, for example in memory 120, memory 220.

In operation 1085, information entered in operation 1080 and/or information captured during the traversal of the CPG and/or bookmarking data may be transmitted to, for example, a CPG developer, party altering the CPG, or a person or institution responsible for updating the CPG. Such information may include anonymous identification of the patient (e.g., via a number), gender, age and ethnicity, and other information described herein. The information transmittal may be electronic, e.g., via Internet 10, and paperless.

In operation 1090, the person or institution, or the CPG developer, may update the CPU, for example based at least in part on the outcome entered in operation 1080, and/or on analysis of one or more CPG outcomes, instances of CPG traversals, etc.

In operation 1095, an updated version of the CPG may be transmitted to the entity storing the CPG (e.g. computer 101, server 200), and received by that entity. The update may be electronic, e.g., via Internet 10.

By capturing the outcomes as recorded during traversals of the CPGs, the study of what works and what doesn't work, the differences in response due to age/gender/ethnicity, the potential side effects, the identification of which pathway provides the best outcomes, are facilitated via the ubiquitous use of CPUs and the ability to record and analyze the machine readable data. The data collected can be sorted by drug, manufacturer, disease processes, etc. With this data, institutions such as the developers of CPGs can evaluate the effectiveness and or appropriateness of the CPG in use; drug manufacturer can evaluate and attempt to determine the cause of the differences in responses based on gender/age/ethnicity; researchers can determine the best alternative pathways to improve the quality of healthcare; and the Agency for Healthcare Research and Quality (AHRQ) through the Health and Human Services Department can design reimbursement differentials based on outcomes.

Other operations or series of operations may be used. The flow shown in FIG. 3 is an example of one of several flows which may occur with embodiments of the invention. In other flows a bookmark or pause need not be used, and an entire question-diagnosis sequence may be completed in one session (e.g., note the flow from operation 1030 directly to operation 1070). An outcome need not be provided.

Allowing a CPG to be traversed using a computer or terminal may save time. In some instances, by the use of branching logic, only a few screens of the guideline may be displayed, and in some cases guidelines may not require more than for example 60 seconds to complete.

CPGs may be updated, and a medical provider may be notified about the updates (e.g., via computer system 101. Information regarding newly discovered treatments or adverse reactions or drug recalls may be introduced CPGs. The update may include a source or an annotation regarding the update. If a practitioner wishes to review the reasons for a particular recommendation, annotations may be available online (e.g., via a server 200), allowing the user to review the commentary and immediately return to the CPG while not delaying the rapid progression through the guideline for others.

A “next” or other similarly labeled button may be displayed on a monitor, and a user indicating on this button (e.g., clicking using a pointing device) to proceed through the CPG may be more efficient than “double clicking.” A number of “multiple selection” screens or pages may be presented within a CPG (e.g., identification of signs or symptoms, selection of a range to record test values, drug combinations, etc.) which may allow the user to select several options on the same screen. In some embodiments, entering information via double clicking may not be used on multiple selection screens so that the user can perform multiple selections before progressing through the CPG pathway. For consistency, since the single select screens may allow for both double clicking of a single option for progression and the multiple select screens allow only “next” for progression, a user may be advised to always use the “next” button.

Referral/Pre-Certification System and Method

In one embodiment, a doctor or other medical service provider who is examining a patient may want to refer that patient for consultation and/or treatment to a specialist, provide a prescription or test, obtain pre-certification, or have the patient admitted to a hospital or other institution. Advance permission may be required for reimbursement of other reasons, from an organization such as reimbursement organizations 300.

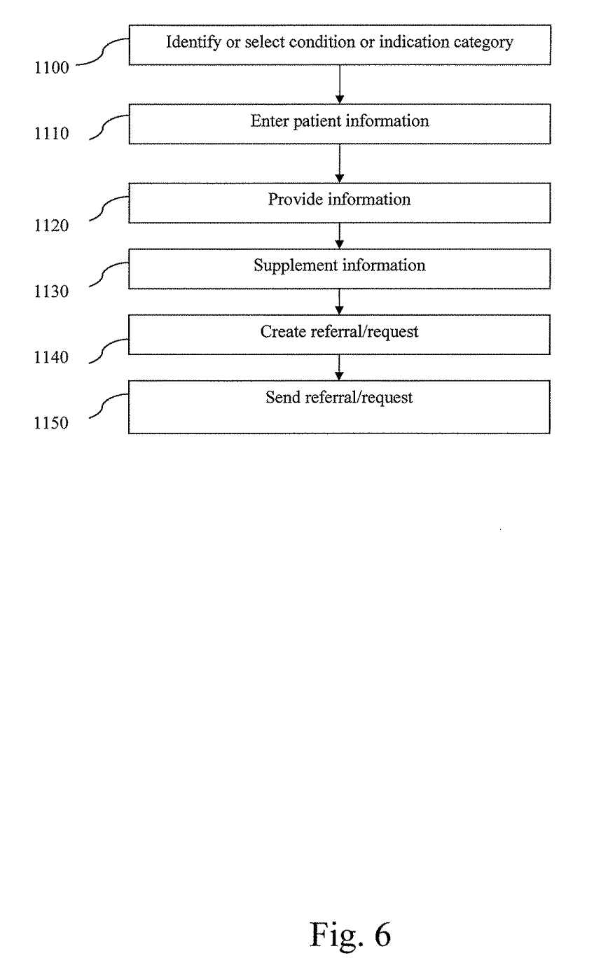

FIG. 6 is a flowchart depicting method of requesting approval for a patient's treatment, pre-certification, admission, referral, or other permission from an organization, according to one embodiment of the invention.

In operation 1100 a system such as computer system 101 may receive information regarding a patient's condition or a specific code or description describing a condition, which may correspond to an indication or referral. For example, a medical service provider may, based on a diagnosis or a suspected diagnosis, select, using medical provider computer system 101 executing indication/referral module 370, one of indication/referral categories in indications/referrals 372.

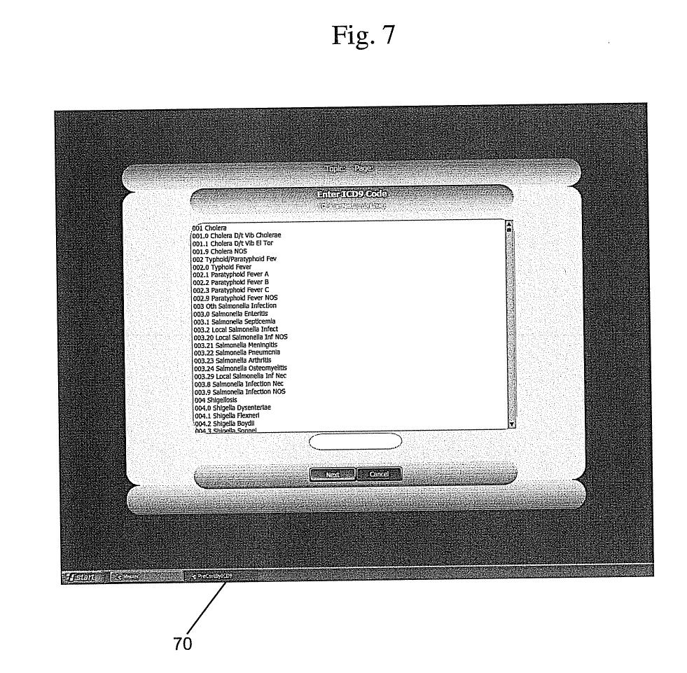

In one embodiment, the provider may be presented with a screen asking the provider to enter a diagnosis or condition, or a code corresponding to the diagnosis or condition. E.g., a CPT or ICD9 code may be accepted by system 101. In one embodiment, the provider may first be asked which type of code or indication/referral choice method he or she wishes to use (e.g., CPT or ICD9 code). After indicating the entry or choice method, the provider may be presented with, for example, a list of codes which accompanying diagnosis/condition descriptions (e.g. “003.23 Salmonella Arthritis”). The user may then enter one of the codes or descriptions. In one embodiment pre-certification selection is entered using a code and referral selection is entered using a text name for a condition or symptoms. In some embodiments, each set of questions may be presented on a separate screen display to a user. FIG. 7 is a screen display showing a list of diagnoses and corresponding codes that may be presented to a physician according to one embodiment of the invention. Other methods of selecting an indication or referral may be used.

In operation 1110, according to some embodiments, a user may be asked to enter and a system such as system 101 may receive further information such as patient information. System 101 may determine whether or not to ask for further information based on the diagnosis or description entered in the previous operation; some diagnoses or conditions may not require further information. For example, the user may be asked to choose among a set of descriptions further defining a condition (e.g., patient has significant clinical symptoms of infection that require treatment in an acute care setting; patient has objective evidence of infection; patient requires antibiotics, etc.). The user may be asked to choose a desired type of institution or doctor to which to refer the patient (e.g., the type of referral being requested from reimbursement organization 300). For example, the user may be asked, if the diagnosis is “asthma”, to choose among “refer to allergist”, “refer to allergist/immunologist”, “refer to pediatric allergist”, “refer to pulmonologist” and “refer to pediatrician.” Each set of further information requested may be presented on a separate screen.

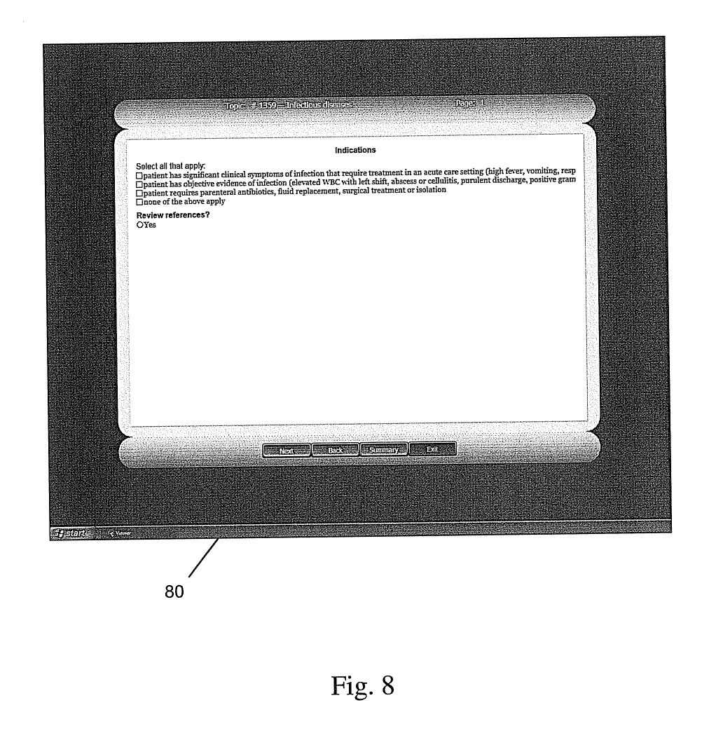

FIG. 8 is a screen display showing questions asked to a physician when requesting a referral according to one embodiment of the invention.

In operation 1120 information may be provided to the provider, such as a probable chance of success (e.g. likely approved, likely not approved), or another probable outcome or result from the organization paying for medical treatment or permitting the referral or admission. For example, the provider may be told a three-day hospital stay is likely to be approved.

In operation 1130 the user may add information to the form not automatically created by the operations above and below (e.g., the name of a managed care company, notes, etc.).

In operation 1140 a process (for example executed on medical provider computer system 101 or server 200) may automatically create an indication or referral request, such as a referral request form. In one embodiment, information entered, such as a diagnosis/condition description or a code referring to a condition, may be used to access a database such as indication/referral categories 372, and an indication may be returned. The indication may be automatically entered in the request. The request may be or include a request of treatment, such as a request for a test, an admission, or a referral to a medical professional. In some embodiments, depending on the information entered or generated in operations 1110-1130, the system may decide to generate a different type of request (e.g., referral, admission).

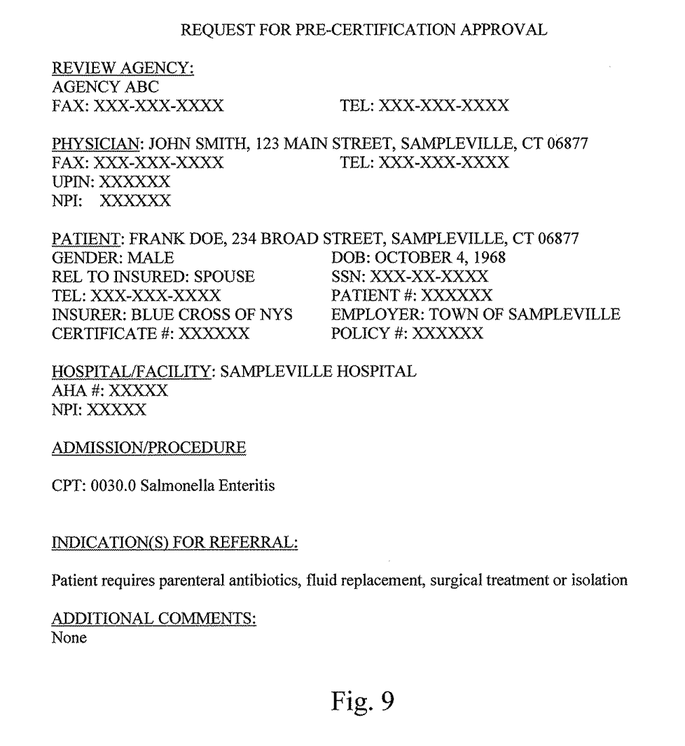

FIG. 9 is an example of a referral request form, according to an embodiment of the invention. For example, the user may create or “print” an indication or referral request (a “print” option may cause a referral to be generated and shown on the screen as it will appear to a viewer or recipient, or cause the invitation to be printed to paper or to another format, e.g. .pdf).

In operation 1150 the indication or request approval for the patient's treatment may be transmitted or sent to a reimbursement organization 300, although in some embodiments the user may first review a “final” version, and then be queried whether or not the user wants to send the indication or request. The user may enter input asking that the indication or request be sent.

A request 374 for a referral, admission, or prescription, may include a specific indication for approval 373, and may be transmitted electronically (e.g. via a network such as the Internet), by facsimile, or in another request to a reimbursement organization 300. The user may print the request and send by conventional methods, such as facsimile.

Information sent with and included in a request 374 can include, for example, the name and address (and other contact information) of the doctor, the unique physician identification number (UPIN) and national provider identifier (NPI) of the doctor, the name, gender, date of birth, social security number, and insurance information of the patient, and the specific request (e.g., a specialist of facility requested). An indication for approval 373 may be, for example, “Asthma: patient requires guidance on environmental control, smoking cessation, complications of therapy, or difficult compliance issues. Refer to pediatric allergist.” Other or different data may be included.

Other operations or series of operations may be used. Other methods of selecting an indication or referral may be used.

The indication may be tailored to precisely and completely answer the question that may be asked by an organization paying for medical treatment or permitting the referral or admission.

A person or process at reimbursement organization 300 may decide whether or not to approve the request or grant pre-certification, and the approval or denial may be sent back to the medical provider computer system 101 via e.g. Internet 10.

Interaction System and Method

A medical professional using computer system 101 and EMR 350 while diagnosing and treating a patient may query drug interaction module 360 for possible interactions or side effects causes by drugs taken by the patient.

EMR 350 and drug interaction module 360 may be executed by computer system 101 (e.g., EMR 350 may be computer code stored on system 101 and executed by processor 110), and computer system 101 may include data such as patient records 352, current drug information 354, and drug interaction data 362. Drug interaction data 362 may include, for example, signs, symptoms, and medical diagnoses (drug literature may include these as side effects rather than diagnoses). A companion listing of drugs may be included. In alternate embodiments, part or all of EMR 350, drug interaction module 360 and associated data and information 352, 354 and 362 may be stored and executed on a different computer system, such as server 200.

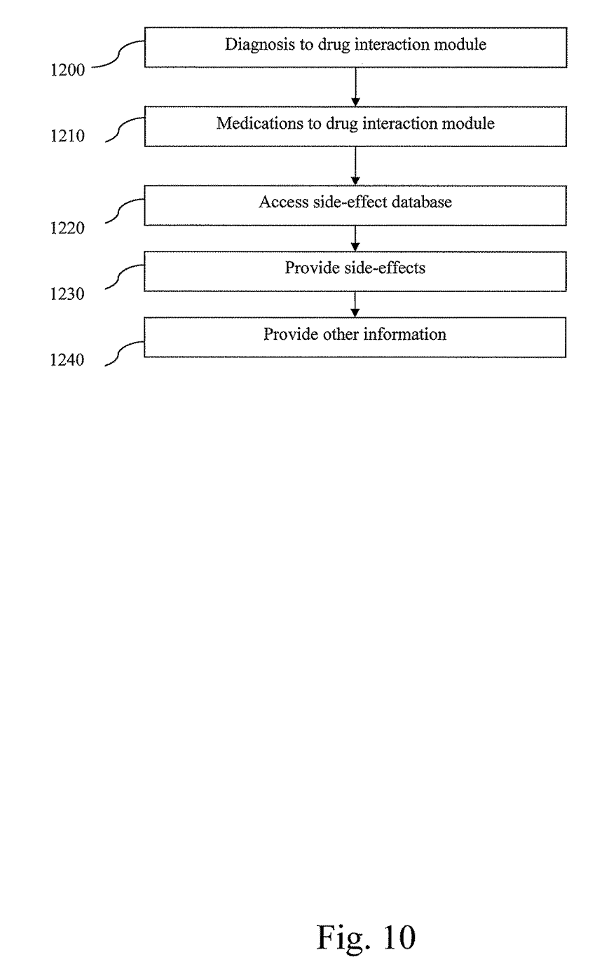

FIG. 10 is a flowchart depicting a method for providing interaction information according to one embodiment of the invention.

In step 1200, during examination, diagnosis and/or treatment of a patient, information regarding the condition of a patient may be input into a software or hardware module. For example a diagnosis, such as the results output by EMR 350, or another diagnosis, may be input into a module or software system, such as drug interaction module 360. In addition, or separately, presenting symptoms or a presenting complaint for a patient may be input into drug interaction module 360. These may be input into drug interaction module 360 automatically (e.g., EMR 350 may communicate with drug interaction module 360), or via a user (e.g., a doctor may input presenting symptoms or a “chief complaint” into drug interaction module 360 via, e.g., interface 142).

In step 1210, a module or system such as drug interaction module 360 may automatically receive or at the prompting of the user for example a list of medications that the patient is presently taking, e.g. from EMR 350 or from a medical professional. In one embodiment, a module such as EMR 350 may be provided with a patient identification, and based on the identification, may use the identification to search in a database such as patient records 352 and may return a list of drugs. Additionally or alternately, drug interaction module 360 may receive a list of medications that the patient is being prescribed or that a doctor plans to prescribe, e.g. from EMR 350 or from a medical professional. For example information from drug information 354 may be accessed by or transferred to drug interaction module 360.

In step 1220, a module may, for each of the medications, access a side-effect database or list and return a list of side effects, if any. For example, drug interaction module 360 may, using a data base such as drug interaction data 362 compare the known side effects of medications the patient is taking to the symptoms or signs the patient is exhibiting, or to a diagnosis. Drug interaction module 360 may determine that a symptom or sign exhibited by a patient, or a diagnosis for a patient, is known to be a likely side effect of a medication currently used by the patient.

In one embodiment, drug interaction data 362 is or includes a database or file with, e.g., three columns (other structures and numbers of columns may be used). Columns A and B contain the names of drugs (e.g., A includes a trade name and B includes a generic name). Column C may contain a listing of known side effects for that drug. Drug interaction module 360 may look in columns A and B for a match on the drug(s). If found, the system may display the side effects listed in Column C for each drug found in column A, for example under the heading of the drug name and title “Known Side Effects”.

In step 1230, if it is determined that a symptom or sign, or a diagnosis, is known to be a likely side effect drug of a drug, a module such as interaction module 360 may provide or display the list of side effects corresponding to the medication, an indication, or other information, e.g. via interface 142, of the possible interaction, for example on a monitory such as and input/output (I/O) device 140.

For example, a patient may present with signs and symptoms of gout. On opening the CPG for gout, the system may review the listing of the patient's prescribed medications and display a flashing warning that the gout may be caused by the prescribed “Forteo” (Teriparatide) medication. Similarly, when a user opens a CPG relating to dermatology or depression for a patient with a presenting complaint of skin reddening or depression, the system may search the data file on prescribed medications and present a (for example flashing or otherwise highlighted) warning that the “Toprol” (Metoprolol) the patient is taking is known to cause skin reddening and depression. The alert may prevent the extensive and costly medical evaluation of the presenting complaint when the user is notified that the complaint is probably caused by a prescribed drug.

In step 1240, other information may be provided. For example, drug interaction module 360 or EMR 350 may also provide information regarding drug recalls. E.g., drug interaction module 360 or EMR 350 may, for example upon receiving information that a certain drug is being recalled, provide to a user of computer system 101, or to a different system, a list of patients, for example by number and physician, or other identifying criteria, so that all patients taking the drug may be notified of the recall.

In response to information that a symptom is caused by a drug currently described, a medical provider, may continue with the evaluation of the presenting complaint ignoring the alert, or evaluate the potential that the presenting complaint is due to the identified drug. The medical provider may then elect to modify the strength, discontinue the drug, or replace the drug with another of the same drug class.

Drug interaction module 360 may also produce a list of symptoms which may be produced by each drug or selected drugs of the drugs currently being taken by or prescribed for the patient. For example, a medical provider may select a drug from a display produced by module 360, and the module may list potential side effects.

Other operations or series of operations may be used. Other methods of selecting an indication or referral may be used.

In alternate embodiments, substances in addition to drugs may be included as causes for symptoms; e.g., food may be included.

Sample Architecture

An embodiment of the invention provides mid-ware software which can interface with any front-end or back-end software. An embodiment of the invention provides mid-ware systems connecting organizations providing care (e.g., hospitals, labs) with organizations developing new treatments, protocols, devices and drugs.

FIG. 11 is a schematic diagram depicting modules according to one embodiment of the invention. The modules may be part of an electronic medical record system and may provide links to the various facilities required to automate the provider's systems with access and data collection. While FIG. 11 describes a certain set of entities and certain links, different embodiments of the invention may use other entities or links, and in addition may not require all entities or links shown. The functionality and modules in FIG. 11 may be integrated into or implemented by, for example, a system as shown in FIGS. 1 and 2.

In FIG. 11, electronic medical records system 900 may be connected with hospital systems 902, laboratory systems 904, radiological systems 905, healthcare management organizations 906, pharmacy links/prescription writer modules 908, and allied health professionals 910. Electronic medical record system 900 may initiate automated processes and facilitate patient record keeping and retrieval. Pharmacy links/prescription writer modules 908 may assist physicians with eliminating drug errors from, e.g., illegible writing and drug/drug interaction.

Mid-ware systems or executable programs may assist providers in the administrative task of obtaining approval for contemplated tests or procedures as well as to provide the “best practice” for a given condition. Pre-certification 920 may provide criteria that meets the requirements imposed by healthcare management companies or organizations for performing tests or procedures such as hospitalization, outpatient surgery, costly radiologic and laboratory tests. Pre-certification 920 may be provided to incentivize physicians to obtain and utilize an EMR in order to minimize the time consuming, paper and phone-based processes of managed care. Referral control and criteria 922 may provide criteria that meets the requirements imposed by healthcare management companies or organizations for granting permission for referral to specialists. Referral control and criteria 922 may be provided to incentivize physicians to obtain and utilize an EMR in order to minimize the time-consuming, paper and phone based processes of managed care. Practice guidelines 924 may provide a provider with the constantly updated approaches to evaluating a patient's complaints in the most cost-effective and beneficial way based on for example evidence-based guidelines at the time most effective—e.g., during the provider-patient encounter. Drug side effects 926 may provide alerts when a patient's presenting symptoms could be caused by, e.g., a drug or food the patient is presently taking. Drug interactions 928 may provide alerts when the patient's drug (e.g., a newly prescribed drug) has a known detrimental effect on the patient's health when given in combination with an existing drug in the patient's drug profile. Outcomes research 930 may provide the data required to perform research regarding the potential different effects based on categories such as for example gender, ethnicity, age, and other factors, as well as the outcomes of the various treatments suggested in practice guidelines allowing for constant improvement in health care delivery. Outcomes research 930 may include a collection of data collected in analyzable format to allow for rapid and complete determination of treatment outcomes.

Midware systems may link to entities such as researchers 940, e.g., institutional individuals who analyze and report on outcomes research data, or other researchers, clinical or practice guideline developers 942, and the pharmaceutical industries 944, which may be provided with outcomes data to determine efficacy of products with respect to, e.g., dosage, ethnic and gender variations, and drug outcomes. Clinical or practice guideline developers 942 may include, for example, institutions of higher learning, medical societies, and organizations devoted to clinical systems improvement. Clinical or practice guideline developers 942 in one embodiment does not include user-developed guidelines, which may institutionalize existing medical practices, which are not always the best practices. Such links may provide data in electronically readable format regarding, for example, the outcomes of treatment in order for these entities to improve the practice guidelines, determine new modalities of treatment, and alter medical formularies for specific sub-groups based on outcomes data.

Clinical or practice guidelines in one embodiment may save healthcare costs by, e.g., eliminating unnecessary and duplicative medical tests. Such guidelines may allow for delivery of the “best practice” of medical care, and may be continually updated to factor, e.g., gender/ethnicity differences through automated outcomes research. Malpractice claims may be avoided by using “community standards.” Public health may be improved through the early recognition of disease states. Alternative medical modalities may be introduced. The physician may be presented with guidelines at the most effective and useful time—during the physician/patient encounter.

Embodiments of the invention may include an article such as a computer or processor readable medium, or a computer or processor storage medium, such as for example a memory, a disk drive, or a USB flash memory, encoding, including or storing instructions, e.g., computer-executable instructions, which when executed by a processor or controller, carry out methods disclosed herein.

It will be appreciated by persons skilled in the art that the present invention is not limited to what has been particularly shown and described hereinabove. Rather the scope of the present invention is defined only by the claims, which follow:

1. A method for providing diagnoses for a medical professional examining patients using clinical practice guidelines (CPGs), the method comprising:
accepting a description associated with a first CPG and selecting the first CPG based on the description;
providing an instruction relevant to a first patient from a first CPG to the professional, the instruction corresponding to a location within the first CPG;
receiving from the professional a bookmark command;
saving an identifier for the first patient and the location of the examination within the first CPG to a storage device;
receiving data from the professional regarding a second patient and providing an instruction to the professional regarding the second patient based on a second CPG;
receiving from the professional a request to continue using the first CPG and an identification of the first patient; and
providing an instruction relevant to the first patient from the first CPG to the professional.

2. The method of claim 1, wherein the instruction comprises a diagnosis or a request for further information.

3. The method of claim 1, wherein the first CPG comprises a decision-tree.

4. The method of claim 1, wherein the location within the first CPG corresponds to a page within the first CPG.

5. The method of claim 1, comprising requesting information regarding the first patient before providing an instruction regarding the first patient.

6. The method of claim 1, wherein the description is a description of the first CPU.

7. The method of claim 1, wherein the description is a diagnosis of the patient.

8. The method of claim 1, wherein the first CPG and the second CPG are the same CPG.

9. The method of claim 1, comprising:
accepting a result based on an instruction relevant to the first patient from the first CPG;
transmitting the result to a party altering the first CPG; and
receiving an updated version of the first CPG.

10. A method for providing clinical practice guidelines (CPGs) for a medical professional examining patients, the method comprising:
accepting at a medical provider computer a description associated with a CPG and selecting the CPG based on the description;
providing an instruction relevant to a patient, from the CPG, to the professional;
receiving, at the medical provider computer, an indication of the outcome for the patient based on the instruction;
transmitting the outcome to a CPG developer; and
receiving from the CPG developer an update to the CPG based in part on the outcome.

11. The method of claim 10, wherein the instruction comprises a diagnosis or a request for further information.

12. The method of claim 10, wherein the CPG comprises a decision-tree.

13. The method of claim 10, wherein the update to the CPT is based on multiple CPG outcomes.

14. A system for providing clinical practice guidelines (CPGs) for a medical professional examining patients, the method comprising:
a computer comprising a memory and a processor, the processor to:
accept a description associated with a first CPG and select the first CPG based on the description;
provide an instruction relevant to a first patient from a first CPG to the professional, the instruction corresponding to a location within the first CPG;
receive from the professional a bookmark command;
save an identifier for the first patient and the location of the examination within the first CPG to a storage device;
receive data from the professional regarding a second patient and provide an instruction to the professional regarding the second patient based on a second CPG;
receive from the professional a request to continue using the first CPG and an identification of the first patient; and
provide an instruction relevant to the first patient from the first CPG to the professional.

15. The system of claim 14, wherein the instruction comprises a diagnosis or a request for further information.

16. The system of claim 14, wherein the first CPG comprises a decision-tree.

17. The system of claim 14, wherein the location within the first CPG corresponds to a page within the first CPG.

18. The system of claim 14, wherein the processor is to:
request information regarding the first patient before providing an instruction regarding the first patient.

19. The system of claim 14, wherein the description is a diagnosis of the patient.

20. The system of claim 14, wherein the first CPG and the second CPG are the same CPG.
